(19) United States
(12) Patent Application Publication
(10) Pub. No.: US 2010/0023557 A1
(43) Pub. Date: Jan. 28, 2010

(54) SYSTEM AND METHOD TO EXTEND A FILE MANAGER USER INTERFACE

(75) Inventor: T. Sureshkumar, Udumalpet (IN)

Correspondence Address: SCHWEGMAN, LUNDBERG & WOESSNER/NOVELL, PO BOX 2938, MINNEAPOLIS, MN, 55402, US

(73) Assignee: NOVELL, INC., PROVO, UT (US)

(21) Appl. No.: 12/180,650

(22) Filed: Jul. 28, 2008

(51) Int. Cl. G06F 12/00; G06F 17/30

(52) U.S. Cl. 707/200; 707/E17.01

(57) ABSTRACT

Systems and methods are presented for extending a file manager user interface to create, edit and organize meta information for files. According to a method embodiment, a file manager is provided to manage files stored in a computer-readable medium. The file manager is adapted to provide a directory view of the files. A wiki engine is integrated with the file manager to provide a wiki view of the files from within the file manager.

### FIELD

This disclosure relates generally to computer file management, and more particularly to systems and methods for extending a file manager user interface to create, edit and organize meta information for files.

### BACKGROUND

A traditional file manager, also referred to as a file browser, is a computer program that provides a user interface for managing files and folders. Traditional file managers usually associate an open action with an external application and are used to organize the file system in a hierarchical fashion. Traditionally, file managers are used to copy, delete, open and move files between folders, and provide a simple view of files and folders, such as an icon view, a list view, and a film strip view for images and movies.

Although the graphical shells of file managers provide an interface to create, open, list and delete files and folders, they do not provide a way to organize user's data beyond the hierarchical arrangement of folders, sub-folders and files. To alleviate this forced abstraction, users tend to use a very long name to assist them in recognizing the file, and also arrange the files and folders in a hierarchical fashion to organize them according to their logical reasoning.

To assist users in cross-referencing files, some file systems provide links between files and some file systems allow users to add meta information to the files. For example, a user may create an office document and add additional attributes like Author, Sources, Year, Revision to the document as supported by the application format. Otherwise, a user may collect a lot of information in the form of files from various sources such as images, spreadsheets, documents etc., and then organize these files by creating a new document or HTML file that ties all of them together.

Many file managers do not display meta information. Some of the file managers like Windows Explorer provide a way to look at some of the meta information (e.g. author, title, etc.) in columns, but do not provide a way to edit them. Some file managers display index.html if there are any files in the folder, but they do not provide editing capabilities.

Wiki is a content organization system. Wiki allows a user to edit user contents. Wiki provides a compact syntax for formatting the user content quickly and effectively, unlike the tag driven html syntax.

### SUMMARY

According to a method embodiment, a file manager is provided to manage files stored in a computer-readable medium. The file manager is adapted to provide a directory view of the files. A wiki engine is integrated with the file manager to provide a wiki view of the files from within the file manager.

This Summary is an overview of some of the teachings of the present application and not intended to be an exclusive or exhaustive treatment of the present subject matter. Further details about the present subject matter are found in the detailed description and appended claims. Other aspects will be apparent to persons skilled in the art upon reading and understanding the following detailed description and viewing the drawings that form a part thereof, each of which are not to be taken in a limiting sense. The scope of the present invention is defined by the appended claims and their equivalents.

### BRIEF DESCRIPTION OF THE DRAWINGS

FIG. 1 illustrates an embodiment of a file manager with Wiki capability.

FIGS. 2-3 illustrate an ice cream recipe example using an embodiment of a file manager with wiki functions.

### DETAILED DESCRIPTION

The present subject matter combines a file manager with a wiki engine to provide a user interface to organize files. Wiki was primarily used for user collaboration but can also be used for personal content organization as it provides better interlinking documents and compact formatting syntax. Wiki software generally provides a way to create and edit contents, link various local and remote documents and keep revisions of the pages.

The present subject matter integrates a file manager with a wiki system to extend the functionality of a file manager by providing new views for files and folders as well as a mechanism to edit the views. By integrating a file manager with a wiki, a user is able to define personal views using a simple wiki editor within the file managers. Some embodiments provide a personalized wiki view with the file and folder views of a traditional file manager. Various embodiments provide a way to organize the user's data and provide plugin systems, such as a plugin to publish the data to the internet, a plugin to export the data to a supported file format, or a plugin to share the data on a LAN system.

The present subject matter enhances the file manager using an in-place simple wiki based editor to provide user defined view to a folder and also a capability to edit the meta information and wiki files. A user can quickly edit the view of a folder and edit any wiki files in the folder without relying on external editors. Some embodiments provide a plugin system to further extend the view. The present subject matter also provides a simple method to capture the meta information and the linking of various documents.

A single interface is used to organize thoughts and supporting materials, which are collected digitally in the form of documents, images, spreadsheets and other files. A user has freedom to organize and define his own interpretation about this data beyond the hierarchical form of files and folders. A user has an in-place editing facility within the file manager to quickly create, edit, organize, and link simple pages, which helps in describing other files and folders.

According to various embodiments, a file extension of .wiki is assigned to files of type Wiki. A user can create a wiki file by opening a new file and saving the file with a name and extension as “wiki”. In all folders a default hidden file .wiki may be created. If this hidden file is present, by default, the file manager renders the wiki view with the contents of the file .wiki.

According to various embodiments, clicking on a wiki file within the file manager opens the wiki editor in the same window. Wiki-based editing is fast and simple, as wiki-based files can be edited even with simple editors such as VI, emacs, and notepad; whereas, HTML editing is harder with lot of ankling brackets and the need for special software to edit HTML files (WYSWYG). A user can organize the information as he does in a web page. The contents of files and folders can be cross linked in wiki pages. Other wiki pages also can be linked. For example, when a user visits a directory, the user-defined wiki view clearly says what the folder is about and information about all other files. Plugins can be used to quickly publish the organized information to the internet as web pages.

Some embodiments use the file manager as a primary interface to files and folders and provide wiki capabilities to file manager. For example, the file manager can be an existing file manager that provides basic views and the functionality of managing the underlying file system interface. Some embodiments extend wiki functionality on an existing file manager. A system embodiment consists of a traditional file manager, hidden meta information files, a wiki engine and a wiki editor.

The proposed system needs to store user-defined content and other information in a persistent location. Some embodiments store them in the content of directory itself. Each directory in a file system is a list of file names and information about files, such as inode number, size, name of the file, etc. The directory content in the file system could be changed to provide more slots to add meta information to the file, but this approach is complex as it involves a considerable change in kernel file system modules. A simpler approach stores meta information about files and directories in a hidden file in the same directory. For example, the name of the default wiki view file may be “.wiki”. Hidden files in the directory are used to store caching information, revisions of wiki pages and other temporary information.

A system embodiment includes a wiki-based interface in the file manager, which can be used to directly edit meta information about files and folders without restriction on the kind of information that can be attached to a folder. For example, if user stores files about a project, he can add meta information about the project's files in a wiki file stored in the same folder as the original file. On visiting the folder, the file manager is adapted to render a wiki view (a user defined view for that folder) based on the information in the wiki file.

Assuming that the user wants to do research on a food recipe, for example, he may collect files of various formats (e.g. pdf, word processing, spreadsheets, web pages, images and other information from various sources). Traditionally, the user would put them all in single folder or arrange them in a logical manner. For example, the data could be stored in a folder entitled “recipe-name” that includes an “images” subfolder and a “methods” subfolder, were the images subfolder includes image files illustrating recipe steps and the methods folder includes word processing files or pdf files or files of other file format. The user could then write a web-page or a document to combine this information together.

However, with the wiki-based approach disclosed herein, the user can save all the documents, images, and other files into the same folder. When visiting the folder, the wiki-based file manager lists them as usual providing a simple view of each file, its size and its type, along with a menu “start wiki”. Clicking the “start wiki” menu opens a wiki editor in the same window, which the user can use to add meaningful information to organize the contents of the folder according the user's preference. If the folder does not include a user-edited wiki, some embodiments show a default view which resembles a traditional file manager interface.

According to various embodiments, the system architecture is based on the Gnome Linux desktop's file manager called Nautilus. Nautilus is a spatial file manager. Nautilus includes an IO layer, an intermediate utility layer providing necessary abstractions, and application layer providing views. The present subject matter extends the application layer to provide a view based on a wiki engine. Nautilus provides a base file manager directory view (FMDirectoryView), and further provides a file manager list view (FMListView) and a file manager icon view (FMIconView).

An embodiment extends the FMDirectoryView with a new class called “FMWikiview” which reads the directory entries and also reads the hidden file called “.wiki”. If there are no files called “.wiki” in the active folder in view, then according to some embodiments, FMWikiview renders a default wiki view. For example, an embodiment provides a default wiki view that includes a list of hyperlinks to all files and folders in the current folder.

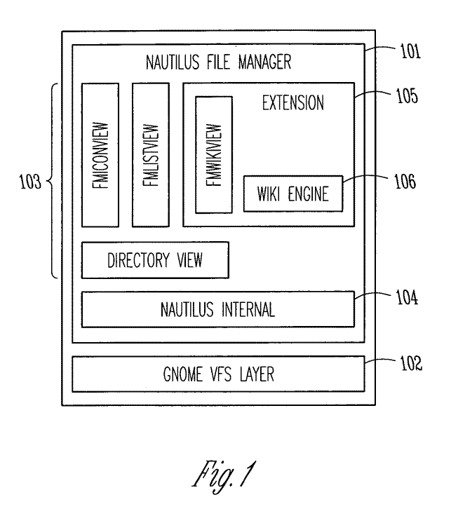

FIG. 1 illustrates an embodiment of a file manager 101, such as a Nautilus file manager, on a virtual file system (VFS) layer 102, such as a GNOME VFS layer. The illustrated file manager includes an application layer 103 to provide views and an intermediate utility layer 104 between the application layer and a virtual file system (VFS) layer 102. The application layer is adapted to provide a file manager directory view (FMDirectoryView), and a file manager list view (FMListView) and a file manager icon view (FMIconView). The illustrated application layer is adapted to provide the wiki view (FMWikiView) through the extension 105 of the application layer. As illustrated, the application layer is extended to include a wiki engine 106, which includes a rendering engine and an editing engine, as discussed below.

A wiki engine renders the user specific wiki files into the view. The wiki engine follows the mediawiki format of wikis, and includes a rendering engine and an editing engine. The rendering engine renders the wiki content whereas the editing engine edits a specified wiki. The editing window is displayed within the file manager itself. Thus, the need for external editor for small files can be completely removed. An option to right click anywhere in the view and to create a new wiki file/folder is given. The rendering engine also takes care of linkages between the wiki pages. While rendering a wikipage, if there are any text whose name is the same as another wiki or any file, some embodiments create a hyperlink in the document which points to the original content.

Some embodiments use a wiki feature that maintains editing revisions allowing users to go back and forth in the revisions, and some embodiments do not include this feature. A hidden database can be used to keep revisions of wiki files. The database can be a simple binary file or a standard sqlite database. The database can be hidden with name .wikidb.

Meta information and user content about files and folders are saved as hidden files under the current directory. For example, “.wiki” file types are rendered when a directory is visited. The “.wiki” file is based on mediawiki's file format. If this file is deleted or never created, then there will not be user-created wiki-based view available. Rather, some embodiments provide a default wiki view which will be similar to a traditional file view.

In addition to the hidden file “.wiki”, the user can have any number of wiki entries in the folder as files with an extension “.wiki”. Where a user plans a trip and to collect details about trip, for example, the user creates a new wiki entry through menu or just creates a file called “Planner.wiki.” The user can cross-link such wikis in any other wiki files. According to some embodiments, the wiki file manager also provides default menu entries which are available in all wiki software, such as “What links here?” and “Special Pages”.

In some embodiments, the wiki-based file manager also provides a plugin framework to provide a way to extend the functionality by third party developers and a program API (Application Program Interface) for use by the plugins. An API can collect the wiki files, the wiki properties, file list and folder list. The plugin can make use of these APIs and provide additional functionality in non-intrusive way.

An example of such plugin is an “Export” plugin such as may be provided using a button on the standard wiki view. By clicking this, the plugin collects the current wiki displayed on the screen and also all the linked wiki pages, and then exports them as HTML, XML, PDF, Openoffice Document, YAML or any other supported format.

Another plugin is a “Publish” plugin. This plugin asks remote server, username and password from the user and then publishes the current wiki page and other wikis, to a remote server with variety of protocols, such as WebDAV, FTP, etc. By using the Wikiview and this plugin, a user effectively organizes the file system as well as he can publish the thoughts directly to web from a simple interface.

Another plugin is a “Share” plugin. This plugin makes the current directory a samba share. The “Share” plugin asks the user for a list of mailing addresses and user names, and then adds these users as access control list primitives to the share. The “Share” plugin sends mails to the respective users, who then can start collaborating on the shared folder and also the wiki. Thus, the “Share” plugin provides users with a collaborating wiki.

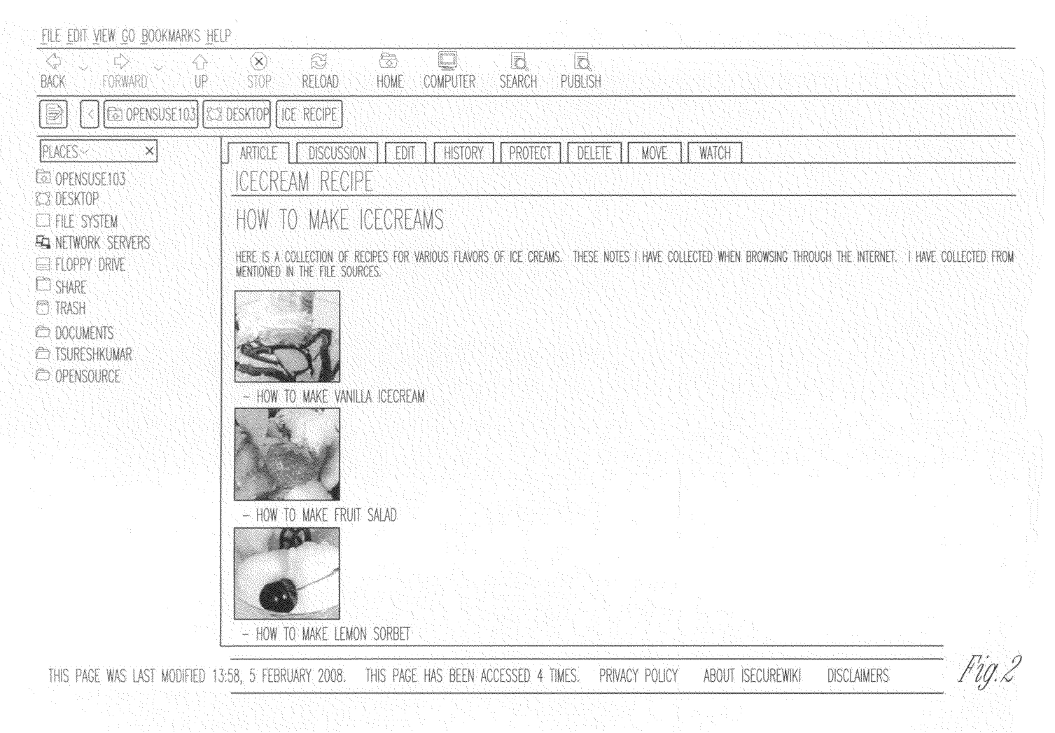

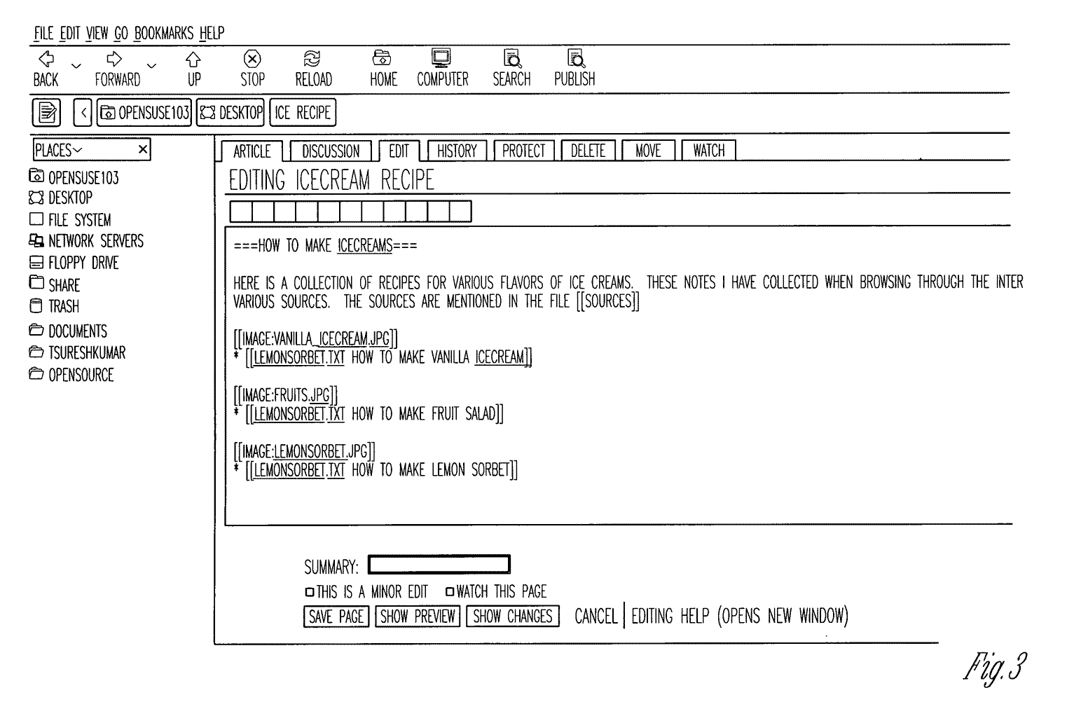

FIGS. 2-3 illustrate an ice cream recipe example using a file manager with wiki functions. FIG. 2 illustrates an icon view of Nautilus for a folder named Ice Cream Recipe. The user can customize the type of view he wants in various way by editing the wiki in place, as illustrated in FIG. 3.

Those of ordinary skill in the art will appreciate, upon reading and comprehending this document, that the present subject is able to provide a wiki-based user interface view inside a file manager for viewing folders and further provides capabilities for a wiki-based editing of simple text files inside wiki view which helps users to quickly create simple documents, a wiki-based organization of user's information, publishing and collaboration of content from file manager user interface, and quick wiki editing within the file manager.

Instead of using hidden files, various embodiments add meta information to file attributes, as some file systems like ext3 supports file attributes. Plugins can be developed for publishing whole files by converting wikis into html pages or as wikis itself to mediawiki or other web content management applications, collaborating by sharing a folder and using wikis, and exporting the wiki content and linked files to another format.

One of ordinary skill in the art will understand that, the illustrated processes and entities can be implemented using software, hardware, and combinations of software and hardware. The methods illustrated in this disclosure are not intended to be exclusive of other methods within the scope of the present subject matter. Those of ordinary skill in the art will understand, upon reading and comprehending this disclosure, other methods within the scope of the present subject matter. The above-identified embodiments, and portions of the illustrated embodiments, are not necessarily mutually exclusive. These embodiments, or portions thereof, can be combined. In various embodiments, the methods are implemented as a set of instructions contained on a computer-accessible medium capable of directing a processor to perform the respective method. The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

The above detailed description is intended to be illustrative, and not restrictive. Other embodiments will be apparent to those of skill in the art upon reading and understanding the above description. The scope of the invention should, therefore, be determined with reference to the appended claims, along with the full scope of equivalents to which such claims are entitled.

1. A method, comprising:
providing a file manager to manage files stored in a computer-readable medium, wherein the file manager is adapted to provide a directory view of the files; and
integrating a wiki engine with the file manager to provide a wiki view of the files from within the file manager.

2. The method of claim 1, wherein providing the file manager includes providing a file manager application layer to provide views of the files from within the file manager, and integrating the wiki engine includes extending the application layer of the file manager with a wiki extension to provide the wiki views.

3. The method of claim 1, wherein integrating the wiki engine with the file manager includes saving a wiki file within a directory, and rendering the wiki file to provide the wiki view of files in the directory from within the file manager.

4. The method of claim 3, wherein integrating the wiki engine with the file manager further includes providing an editing window to edit the wiki file from within the file manager.

5. A method, comprising:
opening a file manager for a file system; and
from within the file manager, selecting a wiki view of files within the file system.

6. The method of claim 5, further comprising editing the wiki view from within the file manager.

7. The method of claim 5, further comprising creating the wiki view from within the file manager.

8. The method of claim 5, wherein creating the wiki view includes creating a wikipage, the method further comprising automatically creating hyperlinks for text in the wikipage that correspond to file names in the directory.

9. The method of claim 5, wherein selecting the wiki view automatically generates a default wiki view if no user-defined wiki view for the directory is within the directory.

10. The method of claim 5, further comprising:
exporting a wikipage to a supported file format;
publishing the wikipage to a remote server; or sharing the wikipage with other users to enable collaboration on the wikipage.

11. A system for managing files stored in a computer-readable memory, the system comprising:
a file manager for managing the files stored in the computer-readable memory; and
a wiki engine integrated with the file manager to provide a wiki view of the files from within the file manager.

12. The system of claim 11, wherein the file manager is adapted to provide a directory view of the files, an icon view of the files, or a list view of the files.

13. The system of claim 11, wherein:
the file manager is adapted to provide a user interface to enable a user of the system to select a view for the file manager from available views; and
the available views include:
a wiki view of the files; and
at least one of a directory view, an icon view, or a list view of the files.

14. The system of claim 11, wherein the wiki engine includes:
a rendering engine to render wiki content in a wiki file into the wiki view; and
an editing engine to display an editing window within the file manager for use to edit the wiki content in the wiki file.

15. The system of claim 14, wherein the rendering engine is adapted to automatically link text in a wiki page to files in a directory with a hyperlink.

16. The system of claim 14, wherein the editing engine is adapted to enable a user to create a new wiki within the editing window of the file manager.

17. The system of claim 11, wherein the system includes the computer-readable medium with the files stored therein within directories, the system further comprising a database in the computer-readable medium to keep revisions of wiki files.

18. The system of claim 11, wherein the system includes the computer-readable medium with the files stored therein within directories, the system further comprising hidden files within a directory to save meta information and user contents about files and folders in the directory, wherein the hidden files include a wiki file.

19. The system of claim 11, wherein the file manager is a spatial file manager that includes an application layer to provide views and an intermediate utility layer between the application layer and a virtual file system (VFS) layer, wherein the application layer is adapted to provide the wiki view.

20. The system of claim 19, wherein the application layer is adapted to provide a file manager directory view (FMDirectoryView), and a file manager list view (FMListView) and a file manager icon view (FMIconView).

21. The system of claim 11, wherein the VFS layer is a Gnome VFS layer and the spatial file manager is a Nautilus file manager.

22. The system of claim 11, further comprising a plugin framework adapted to:
export a wikipage to a supported file format;
publish the wikipage to a remote server; or
share the wikipage with other users to collaborate on the wikipage.
